(19) United States
(12) Patent Application Publication
(10) Pub. No.: US 2018/0049426 A1
(43) Pub. Date: Feb. 22, 2018

(54) ROLYNS POOP PREVENTER

(71) Applicant: Rosalyn Russell Francis, Virginia Beach, VA (US)

(72) Inventor: Rosalyn Russell Francis, Virginia Beach, VA (US)

(21) Appl. No.: 15/681,068

(22) Filed: Aug. 18, 2017

Related U.S. Application Data
(60) Provisional application No. 62/376,724, filed on Aug. 18, 2016.

(51) Int. Cl. A01M 29/08

(52) U.S. Cl. CPC A01M 29/08

(57) ABSTRACT

A pet training method embodying a lawn accessory device for preventing pets from urinating and defecating on lawns is provided. The device has a reflective body providing a cavity for retaining salt water. The body includes a base with a plurality of legs for maintaining an upright orientation of the device even on a supporting surface have lawn growth. When placed in such lawn growth, the reflective properties of the container filled with water within its cavity discourages dogs and other pets from entering the surrounding area.

### CROSS-REFERENCE TO RELATED APPLICATION

This application claims the benefit of priority of U.S. provisional application No. 62/376,724, filed Aug. 18, 2016, the contents of which are herein incorporated by reference.

### BACKGROUND OF THE INVENTION

The present invention relates to pet training and lawn accessory method and device and, more particularly, to a pet training method embodying a lawn accessory device adapted for preventing pets from urinating and defecating on lawns.

The lawns of homes are commonly used by pets as locations for urinating and defecating, much to the chagrin to the home dweller. Preexisting methods and devices for prevention of such events are impractical, inconvenient, unaffordable, heavy, complex, and/or unsanitary.

As can be seen, there is a need for a pet training method embodying a lawn accessory device for preventing pets from urinating and defecating on lawns, wherein the lawn accessory device is affordable, durable, and easy to use and maintain.

### SUMMARY OF THE INVENTION

In one aspect of the present invention, a device for preventing pet animals from urinating or defecating on a surface area includes a container having a reflective plastic body defining a cavity for retaining a fluid; a base connected to a bottom portion of the body; and a plurality of legs extending from the base so that each distal end of said legs are between one to three inches below the bottom of the body.

In another aspect of the present invention, the device includes a container having a reflective material body defining a cavity for retaining a salt water; a base connected to a bottom portion of the body; a neck extending from an upper portion of the body, the neck providing a neck opening communicating with the cavity; a cap dimensioned to removably engage the neck so as to provide a watertight seal of the neck opening; and a plurality of legs extending from the base so that each distal end of said legs are between one to three inches below the bottom of the body, wherein the plurality of legs is dimensioned to keep the container in an upright orientation while the plurality of legs is embedded in a grass-covered surface area.

In yet another aspect of the present invention, method of preventing pet animals from urinating or defecating on a surface area, includes the steps of providing a transparent container filling the container with water and Epsom salt; and supporting the container in an upright orientation on the surface area. In certain embodiments, said container is one of the devices described immediately above.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention; and

FIG. 2 is a section view of an exemplary embodiment of the present invention, taken along line 2-2 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pet training method embodying a lawn accessory device for preventing pets from urinating and defecating on lawns. The device has a reflective body providing a cavity for retaining salt water. The body includes a base with a plurality of legs for maintaining an upright orientation of the device even on a supporting surface have lawn growth. When placed in such lawn growth, the reflective properties of the container filled with water within its cavity discourages dogs and other pets from entering the surrounding area.

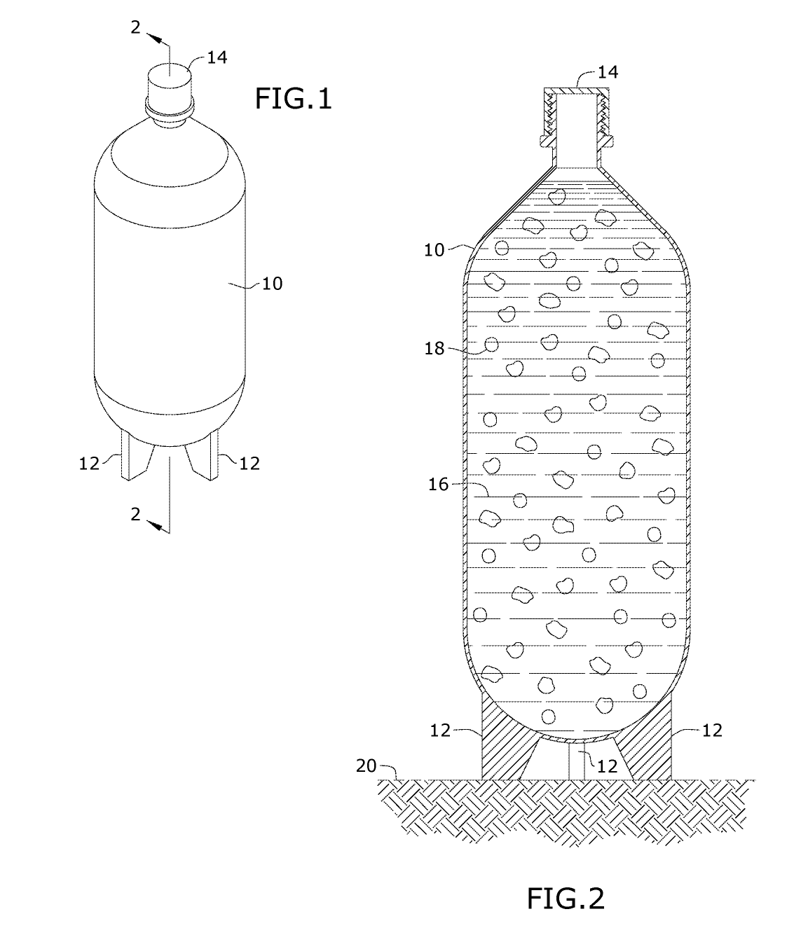

Referring to FIGS. 1 and 2, the present invention may include a pet training method embodying a lawn accessory device 50 for preventing pets from urinating and defecating on lawns. The novel device 50 may include a reflective container 10. The reflective property may result from a transparent, semi-transparent and/or clear plastic material. In certain embodiments, the container 10 may be a clear plastic bottle measuring approximately 11 inches high and having approximately 5-inch diameter. The container 10 may have a base 13 dimensioned and adapted to stably support the container 10 in an upright position, as illustrated in the FIGS., along the supporting surface 20, which may include a ground line providing grass and other growth (not shown) associated with lawns and yards. To wit, the base 13 may include a three or more (though only three are shown) legs 12 extending one or more inches beyond the base 13/bottom portion of the body 24, so as the ‘stand’ above or within such growth.

The container 10 may include a neck 22 extending from a body 24, wherein the body 24 provides a cavity communicating with a neck opening 26 for removably retaining fluid 16 within the cavity, as illustrated in FIG. 2. The neck 22 may provide threading for securely engaging a cap 14 for providing a fluid-tight closure of the neck opening 26.

A method of using the present invention may include the following. The novel device 50 disclosed above may be provided. A user may fill the cavity with water contain salt 18 to ensure the water remains clear. The salt 18 may be Epsom salt or the like. Then the user places the novel device 50 in the yard or lawn they want to keep free of pet urine and feces, as the presence of the brightly reflective salt water retaining novel device 50, the inventor has discovered, discourages dogs and other pets from entering the area. The novel device 50, colloquially known as ROLYNS POOP PREVENTER, is easy to set up and durable for years of effective use. Furthermore, the novel device 50 occupies the space or area in a non-descript manner, providing the feel of a low-profile lawn accessory.

It should be understood, of course, that the foregoing relates to exemplary embodiments of the invention and that modifications may be made without departing from the spirit and scope of the invention as set forth in the following claims.

What is claimed is:

1. A device for preventing pet animals from urinating or defecating on a surface area, comprising:
a container having a reflective plastic body defining a cavity for retaining a fluid;
a base connected to a bottom portion of the body; and
a plurality of legs extending from the base so that each distal end of said legs are between one to three inches below the bottom of the body.

2. The device of claim 1, wherein the fluid is salt water.

3. The device of claim 1, wherein the plurality of legs is dimensioned to keep the container in an upright orientation while the plurality of legs is embedded in a grass-covered surface area.

4. The device of claim 1, further comprising a neck extending from an upper portion of the body, the neck providing a neck opening communicating with the cavity; and a cap dimensioned to removably engage the neck so as to provide a watertight seal of the neck opening.

5. A device for preventing pet animals from urinating or defecating on a surface area, comprising:
a container having a reflective material body defining a cavity for retaining a salt water;
a base connected to a bottom portion of the body;
a neck extending from an upper portion of the body, the neck providing a neck opening communicating with the cavity;
a cap dimensioned to removably engage the neck so as to provide a watertight seal of the neck opening; and
a plurality of legs extending from the base so that each distal end of said legs are between one to three inches below the bottom of the body, wherein the plurality of legs is dimensioned to keep the container in an upright orientation while the plurality of legs is embedded in a grass-covered surface area.

6. A method of preventing pet animals from urinating or defecating on a surface area, comprising the steps of:
providing the device of claim 1;
filling the cavity with water and Epsom salt; and
supporting the container in an upright orientation on the surface area.

7. A method of preventing pet animals from urinating or defecating on a surface area, comprising the steps of:
providing the device of claim 1;
filling the cavity with water and Epsom salt; and
supporting the container in an upright orientation on the surface area

8. A method of preventing pet animals from urinating or defecating on a surface area, comprising the steps of:
providing a transparent container
filling the container with water and Epsom salt; and
supporting the container in an upright orientation on the surface area.
